(19) United States
(12) Patent Application Publication
(10) Pub. No.: US 2021/0049726 A1
(43) Pub. Date: Feb. 18, 2021

(54) SYSTEM, METHOD, AND PLATFORM FOR GENERATING REAL-TIME PORTFOLIO EXPECTED VALUE

(71) Applicant: The Action Network, Inc., New York, NY (US)

(72) Inventor: Daniel Hood, Marina Del Rey, CA (US)

(21) Appl. No.: 16/993,984

(22) Filed: Aug. 14, 2020

Related U.S. Application Data
(60) Provisional application No. 62/886,548, filed on Aug. 14, 2019.

(51) Int. Cl. G06Q 50/34; G06Q 30/02; G06F 17/18; G07F 17/32

(52) U.S. Cl. CPC G06Q 50/34; G06Q 30/0283; G07F 17/323; G07F 17/3288; G06F 17/18

(57) ABSTRACT

A system, method, and electronic online platform provide an expected value of a portfolio of wagers in real-time as live in-game data is provided to a process for calculating a current probability.

### CROSS REFERENCE TO RELATED APPLICATIONS

This application claims the benefit of U.S. Provisional Patent Application No. 62/886,548, filed on Aug. 14, 2019, the contents of which are fully incorporated by reference herein.

### BACKGROUND

The embodiments herein relate generally to wagering systems and more particularly, to systems, methods, and platforms for generating a real-time portfolio expected value.

Current portfolio tracking for wagering generally provide a list of bets or wagers on an event by a user, but information is not provided about those wagers while the underlying events are progressing. During the performance of wagered-on events, a user may wish to adjust their betting strategy to avoid heavy losses or maximize returns. These lists of bets, however, do not convey any sense of how the portfolio of bets is performing during games, which may affect a user's ability to wager on subsequent games depending on how the portfolio is performing.

Accordingly, there is a need to provide users with a current expected performance of a betting or wager portfolio to adjust strategies.

### SUMMARY

According to an embodiment, a computer program product for generating an expected value for a portfolio of wagers is disclosed. The computer program comprises a non-transitory computer readable storage medium having computer readable program code embodied therewith. The computer readable program code is configured, when executed by a computer processing unit, to: receive a plurality of stored wagers for a user account; receive a stored file of historical pre-game betting data; generate a pregame winning probability model of the plurality of stored wagers; receive live in-game data for the plurality of stored wagers; generate a real-time winning probability for the plurality of stored wagers using the model and based on the received live in-game data; and generate an expected value for the portfolio of wagers based on the real-time winning probability of the plurality of stored wagers.

A method for determining an expected value of a portfolio of wagers is disclosed. The method includes determining, by a computer, a first wager data set corresponding to a first category of wagers on an event and a second wager data set corresponding to a second categories of wagers on the event; receiving, by the computer, a third data set comprising game data of the event; calculating, by the computer, a first win probability of the first wager data set based on a first win probability model and the third data set; calculating, by the computer, a second win probability of the second wager data set based on a second win probability model and the third data set; and determining an expected value of the first and second wager data sets based on the first win probability and the second win probability.

A non-transitory computer readable medium is disclosed having stored thereon software instructions that, when executed by a processor, cause the processor to generate a win probability of a wager, by executing the steps. The steps include determining, by a computer, a first wager data set corresponding to a first category of wagers on an event and a second wager data set corresponding to a second categories of wagers on the event; receiving, by the computer, a third data set comprising game data of the event; calculating, by the computer, a first win probability of the first wager data set based on a first win probability model and the third data set; calculating, by the computer, a second win probability of the second wager data set based on a second win probability model and the third data set; determining an expected value of the first and second wager data sets based on the first win probability and the second win probability.

### BRIEF DESCRIPTION OF THE FIGURES

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 is a block diagram of a bet win probability model development according to an exemplary embodiment of the subject technology.

FIG. 2 is a block diagram of a bet win probability model implementation according to an exemplary embodiment of the subject technology.

FIG. 3 is a block diagram of a portfolio expected value model implementation according to an exemplary embodiment of the subject technology.

FIG. 4 is a block diagram of a computing device implementing aspects of exemplary embodiments.

### DETAILED DESCRIPTION OF CERTAIN EMBODIMENTS

In general, and referring to the Figures, embodiments of the disclosed subject technology address the problems associated with tracking the expected performance of a portfolio of wagers. Aspects of the disclosure provide actionable information to users instead of simply listing their active wagers with no supplemental information. The embodiments disclosed automatically calculate the expected returns on all wagers currently underway. As may be appreciated, the automated information gives users additional information that will influence any additional wagers they would be interested in potentially placing.

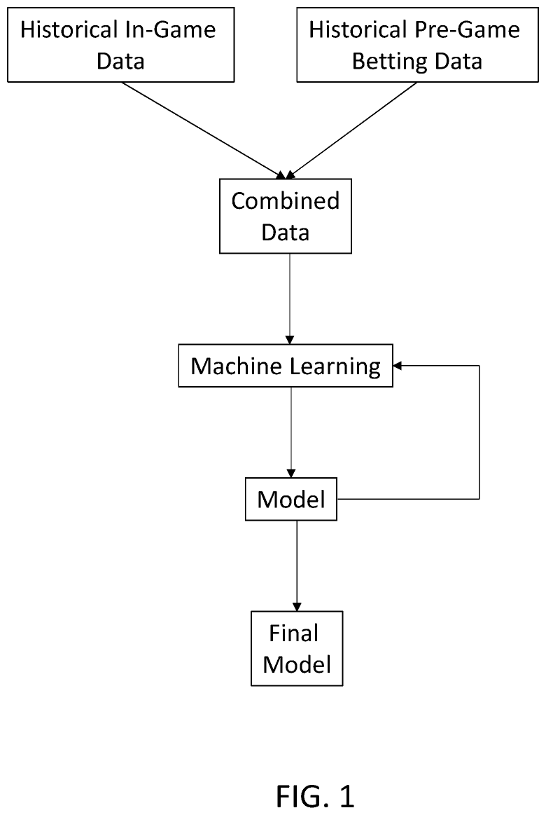

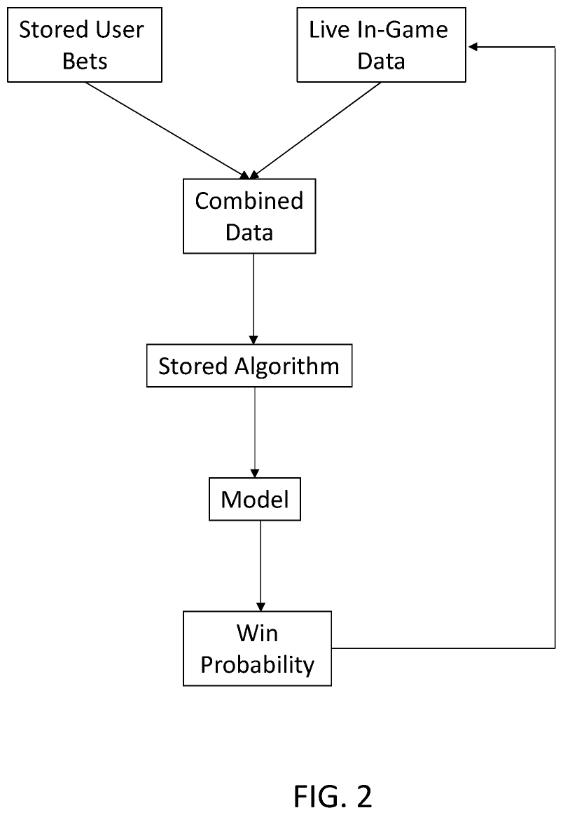

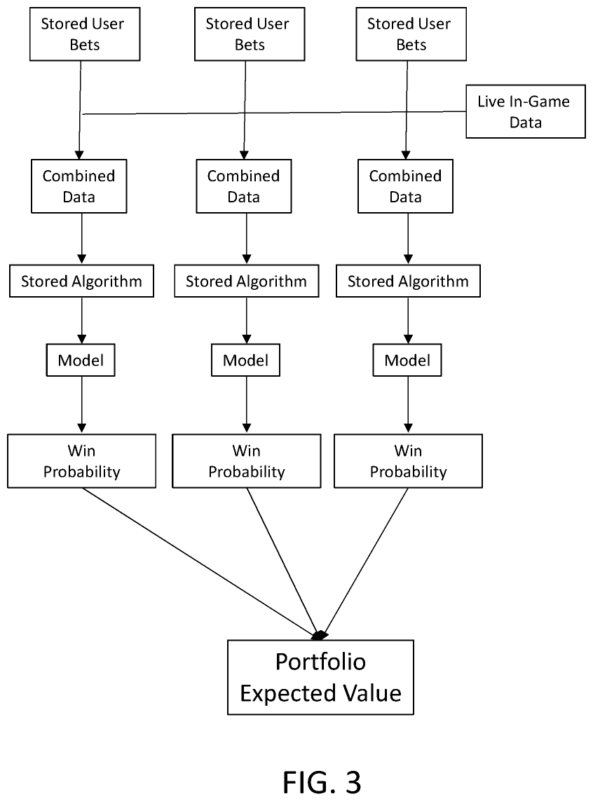

Referring now to FIGS. 1-3, process embodiments include two primary components. The first component is the development and implementation of a bet win probability model (see FIGS. 1 and 2). The win probability model and its implementation provide the ability to convert live in-game data and stored betting data about a game into the probability of those bets winning. The second component is the summation of a user's set of expected bet values into a portfolio, along with a corresponding win probability. See FIG. 3.

In FIG. 1, a database of historical in-game data and a database of historical pre-game betting data may be used to generate a model to predict the probability of a pre-game bet being successful. The generated model may be stored for use in predicting a bet's win probability. For example, the win probability model may be developed using the techniques described in U.S. application Ser. No. 16/993,881, filed on Aug. 14, 2020, the contents of which are incorporated herein by reference.

In FIG. 2, the generated model may be implemented using live in-game data. The live in-game data and a user's stored bets may be used to predict the win probability of the bets. For example, the win probability model may be implemented using the techniques described in U.S. application Ser. No. 16/993,881, filed on Aug. 14, 2020, the contents of which are incorporated herein by reference, using a first data set including one or more bets or wagers may by the user for the one or more games and a second data set including data specific to the sport of the respective one or more games. The win probability of the bets may be used to generate an expected value of return for all bets placed in the portfolio. According to an embodiment, different win probability models or algorithms may be developed depending on a predefined category of wager or bet type. Accordingly, the respective win probability models or algorithms may be optimized specific to a respective predefined category of wager or bet type.

FIG. 3 illustrates a process for generating the expected value for a bet or wager portfolio. As will be understood, the description of the portfolio expected value implementation shown is an example only and different implementations may be performed depending on the elements of a user's particular wagers in the portfolio. The process for generating the expected value of the portfolio may include parallel processes to determine the win probability and expected value according to different categories of bet or wager types, as explained below. Although only three different parallel processes are illustrated, any number of parallel processes may be utilized according to any number of different categories of bet or wager types.

According to an embodiment, a portfolio of wagers or bets of one or more users may be stored by the computer as one or a plurality of first data sets. For example, as illustrated at FIG. 3, the portfolio may include a plurality of different types of stored user bets, such as a spread type bet(s), a totals type bet(s), and a player proposition type bet(s). The different types of stored user bets may be categorized into different data sets, and the different data sets of stored user bets may include one or more bets. According to an embodiment, the different categories may correspond to different type of events, such as different event types (e.g., different game types, different games, different geographical locations, etc.). For example, a first category of bets or wagers may be stored as the first data set, and a second category of bets or wagers may be stored as a live in-game or event data set. The one or plurality of first data sets may be updated as the user places additional wagers or bets.

One or more data sets of live in-game or event data may be received by the computer via an application programming interface (API), communicated to the computer via a data connection, and/or downloaded by the computer. The computer may store an event data set including data specific to the event or sport of the respective one or more games, such as real-time or live in-game data, including time remaining in the game, total elapsed time of the game, score, data specific to a football game (e.g., down, distance, current yardline, team possession, number of timeouts remaining/taken by a team, etc.), data specific to a basketball game (e.g., possession arrow or team possession of the ball, number of timeouts remaining/taken by a team, score per minute, points scored by minute by a team, etc.), data specific to a baseball game (e.g. strikes and/or balls for an at-bat, total strikes and/or balls in an inning, total strikes and/or balls in a game, number of outs, hitter order, baserunners, etc.), and/or data specific to other types of game or sports.

The one or more event data set may include data specific to the types of bets. For example, a first category of live in-game data may be provided for the first data set corresponding to a first category of bets; a second category of live in-game data may be provided for the first data set corresponding to a second category of bets; and a third category of live in-game data may be provided for the first data set corresponding to a third category of bets.

For example, the data sets described above (e.g., portfolio of wagers or bets, live in-game or event data, etc.) may collectively be a feed data set for the stored win probability algorithm. As illustrated at FIG. 3, the feed data sets may be separated into categories, such as a first feed data set corresponding to a first category of bets, a second feed data set corresponding to a second category of bets, and a third feed data set corresponding to a third category of bets.

According to an embodiment, the different feed data sets may be merged by the computer into a single or merged data set as the feed data set. For example, the data sets corresponding to a first category of bets may be merged into a first single unified corpus of game data, the data sets corresponding to a second category of bets may be merged into a second single unified corpus of game data, and the data sets corresponding to a third category of bets may be merged into a third single unified corpus of game data. The respective merged data sets may be passed to the stored win probability algorithm or model, as described below. According to an embodiment, the data sets corresponding to the respective categories may be grouped and normalized into the merged data set or single unified corpus of game data groups that can be passed as a single data set to the algorithm or model.

As explained in more detail below, the respective feed data sets may be updated periodically or continuously with in-game or event data and/or bets throughout the course of the one or more events or games, at predetermined events during the one or more events or games, and/or upon a request of the user.

As explained above, different win probability models or algorithms may be developed depending on a predefined category of wager or bet type and stored by the computer. According to an embodiment, the same win probability model may be used with respect to the different categories of bet or wager types. The respective stored win probability algorithms or models can be applied to the corresponding feed data sets in order to predict the win probability of the stored user bets on the one or more games. For example, the computer can compare the first and live in-game or event data sets to the stored win probability algorithm or model to determine the win probability for a specific wager or bet. The computer can simultaneously determine the win probability for the different categories of bet or wager types to determine a win probability of the portfolio.

As explained above, the live in-game or event data represents the real-time or live in-game or event data of the one or more games or events. Accordingly, for example, the live in-game data of the respective data sets may change continuously through the course of the one or more games. Accordingly, the win probabilities calculated by the stored win probability algorithms may be updated by updating the feed data set(s) periodically or continuously throughout the course of the one or more games, at predetermined events during the one or more games, and/or upon a request of the user. For example, the feed data set may be updated 1-second, 30-second, 1-minute, or at another predetermined time interval. For example, the feed data set may be updated periodic intervals of elapsed time or time remaining of a game, such as 1-second, 30-second, 1-minute, or at another predetermined time interval. The win probabilities may also be updated based on a predetermined event determined from the live in-game or event data set. For example, as the live in-game or event data set is updated (whether periodically or in real-time), the live in-game or event data set may be monitored for one or more predetermined events in the game. When the system determines that one or more of the predetermined events occurs in the game, it can update the win probability of the bet or wager to display to the user. Accordingly, as the win probabilities are updated, the win probability and/or expected value of the stored user bets as they vary over time and/or event and may be displayed to the user on the user computer or device.

According to an embodiment, when the one or more games are complete and the outcome of the user bets or wagers is known, the win probability model for the user may be updated by updating the first and live in-game or event data sets described with respect to FIG. 1.

Accordingly, and as may be appreciated, the user may be updated in real-time concurrently with the action unfolding in a game associated with the user's wager(s). As the game unfolds, specific wagers related to the game action may be updated as to their probability of winning so the user can, for example, place additional bets in response to their current probabilities of winning.

If the amount of the user's bet is also known, the probability can be multiplied by the respective bet amount to calculate the bet's expected value. The win probability and/or expected value of the stored user bets may be displayed to the user on a user computer or device. The computer can simultaneously determine the expected value for the different categories of bet or wager types to determine an expected value of the portfolio. Accordingly, the user can determine the overall performance of a portfolio of bets in order to determine whether to place additional wagers based on the expected value of a portfolio at any given time.

Accordingly, depending on the expected value of the portfolio, the user may determine whether to place additional bets in a strategy to overcome expected negative returns, or to hedge against current positive returns, or increase positive returns.

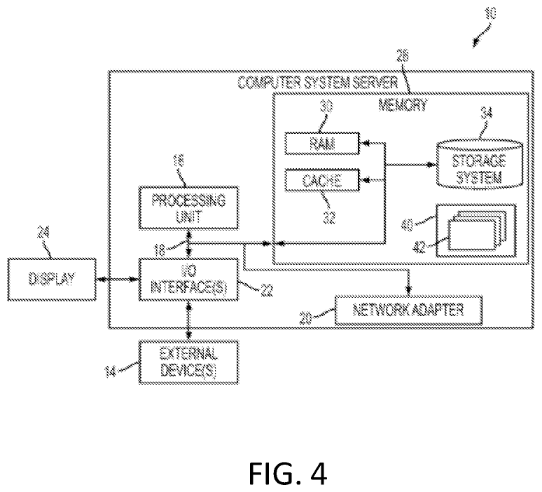

Referring now to FIG. 4, a schematic of an example of a computer system/server 10 is shown. The computer system/server 10 is shown in the form of a general-purpose computing device. The components of the computer system/server 10 may include, but are not limited to, one or more processors or processing units 16, a system memory 28, and a bus 18 that couples various system components including the system memory 28 to the processor 16.

In some embodiments, the computer system/server 10 may be a cloud computing node connected to a cloud computing network (not shown). The computer system/server 10 may be for example, personal computer systems, tablet devices, mobile telephone devices, server computer systems, handheld or laptop devices, multiprocessor systems, microprocessor-based systems, set top boxes, programmable consumer electronics, network PCs, wearable computing devices, and distributed cloud computing environments that include any of the above systems or devices, and the like. Users may use any of the computer systems 10 to interface with a software embodiment to engage with the posting of wagers and generation of real-time expected values as described above. In some embodiments, the invention may be a hosted application and platform which is administered by a server type computer system/server 10. In this context, data or signals from the user-controlled computer systems 10 may be sent to a server(s) 10 to invoke the processes described above. The computer system/server 10 may be described in the general context of computer system executable instructions, such as program modules, being executed by a computer system (described for example, below). The computer system/server 10 may be practiced online which may include distributed cloud computing environments where tasks are performed by remote processing devices that are linked through a communications network. In a distributed cloud computing environment, program modules may be located in both local and remote computer system storage media including memory storage devices.

The computer system/server 10 may typically include a variety of computer system readable media. Such media could be chosen from any available media that is accessible by the computer system/server 10, including non-transitory, volatile and non-volatile media, removable and non-removable media. The system memory 28 could include one or more computer system readable media in the form of volatile memory, such as a random access memory (RAM) 30 and/or a cache memory 32. By way of example only, a storage system 34 can be provided for reading from and writing to a non-removable, non-volatile magnetic media device typically called a “hard drive” (not shown). The system memory 28 may include at least one program product 40 having a set (e.g., at least one) of program modules 42 that are configured to carry out the functions of embodiments of the invention. The program product/utility 40, having a set (at least one) of program modules 42, may be stored in the system memory 28 by way of example, and not limitation, as well as an operating system, one or more application programs, other program modules, and program data. Each of the operating system, one or more application programs, other program modules, and program data or some combination thereof, may include an implementation of a networking environment. The program modules 42 generally carry out the functions and/or methodologies of embodiments of the invention as described herein. For example, the program modules 42 may execute the steps for receiving wagers, accessing pre-game historical betting data, accessing live in-game data, feeding data related to a portfolio of stored bets and current in-game data to an algorithm to generate a probability of winning for individual bets, and calculating an expected value of a portfolio of bets based on the current probability of bets winning as described above.

The computer system/server 10 may also communicate with one or more external devices 14 such as a keyboard, a pointing device, a display 24, etc.; and/or any devices (e.g., network card, modem, etc.) that enable the computer system/server 10 to communicate with one or more other computing devices. Such communication can occur via Input/Output (I/O) interfaces 22. Alternatively, the computer system/server 10 can communicate with one or more networks such as a local area network (LAN), a general wide area network (WAN), and/or a public network (e.g., the Internet) via a network adapter 20. As depicted, the network adapter 20 may communicate with the other components of the computer system/server 10 via the bus 18.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon. Any combination of one or more computer readable media (for example, storage system 34) may be utilized. In the context of this disclosure, a computer readable storage medium may be any tangible or non-transitory medium that can contain, or store a program (for example, the program product 40) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor 16 of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (just X, or just Y, or just Z) and multiple items (i.e., {X and Y}, {X and Z}, {Y and Z}, or {X, Y, and Z}). “At least one of” is not intended to convey a requirement that each possible item must be present.

Although the foregoing description is directed to the embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

I claim:

1. A method for determining an expected value of a portfolio of wagers, the method comprising:
determining, by a computer, a first wager data set corresponding to a first category of wagers on an event and a second wager data set corresponding to a second categories of wagers on the event;
receiving, by the computer, a third data set comprising game data of the event;
calculating, by the computer, a first win probability of the first wager data set based on a first win probability model and the third data set;
calculating, by the computer, a second win probability of the second wager data set based on a second win probability model and the third data set;
determining an expected value of the first and second wager data sets based on the first win probability and the second win probability.

2. The method of claim 1, wherein the data of the event comprises real-time data of one or more games.

3. The method of claim 1, further comprising:
updating the third data set and calculating an updated first win probability of the first wager data set based on the updated third data set and an updated second win probability of the second wager data set based on the updated third data set; and
updating the expected value of the first and second wager data sets based on the updated first win probability and the updated second win probability.

4. The method of claim 3, wherein the third data set is updated in real-time with the event.

5. The method of claim 3, wherein the third data set is updated at a predetermined time interval.

6. The method of claim 3, further comprising:
determining a predetermined event has occurred in the game based on the updated third data set; and
wherein calculating the updated first win probability of the first wager data set and the updated second win probability of the second wager data set occurs after determining the predetermined event has occurred.

7. The method of claim 1, wherein the determining the first data set comprises receiving one or more wagers of the first category from a user account of the user,
wherein the determining the second data set comprises receiving one or more wagers of the second category from the user account of the user.

8. The method of claim 1, wherein the first win probability model comprises a first algorithm based on a first historical game data set and a first historical betting data set associated with the first category of wagers,
wherein the second win probability model comprises a second algorithm based on a second historical game data set and a second historical betting data set associated with the second category of wagers.

9. The method of claim 8, wherein the first algorithm is determined based on a correlation of a first game characteristic and a first wager outcome,
wherein the second algorithm is determined based on a correlation of a second game characteristic and a second wager outcome.

10. A non-transitory computer readable medium having stored thereon software instructions that, when executed by a processor, cause the processor to generate a win probability of a wager, by executing the steps comprising:
determining, by a computer, a first wager data set corresponding to a first category of wagers on an event and a second wager data set corresponding to a second categories of wagers on the event;
receiving, by the computer, a third data set comprising game data of the event;
calculating, by the computer, a first win probability of the first wager data set based on a first win probability model and the third data set;
calculating, by the computer, a second win probability of the second wager data set based on a second win probability model and the third data set;
determining an expected value of the first and second wager data sets based on the first win probability and the second win probability.

11. The method of claim 10, wherein the data of the event comprises real-time data of one or more games.

12. The method of claim 10, further comprising:
updating the third data set and calculating an updated first win probability of the first wager data set based on the updated third data set and an updated second win probability of the second wager data set based on the updated third data set; and
updating the expected value of the first and second wager data sets based on the updated first win probability and the updated second win probability.

13. The method of claim 12, wherein the third data set is updated in real-time with the event.

14. The method of claim 12, wherein the third data set is updated at a predetermined time interval.

15. The method of claim 12, further comprising:
determining a predetermined event has occurred in the game based on the updated third data set; and
wherein calculating the updated first win probability of the first wager data set and the updated second win probability of the second wager data set occurs after determining the predetermined event has occurred.

16. The method of claim 10, wherein the determining the first data set comprises receiving one or more wagers of the first category from a user account of the user,
wherein the determining the second data set comprises receiving one or more wagers of the second category from the user account of the user.

17. The method of claim 10, wherein the first win probability model comprises a first algorithm based on a first historical game data set and a first historical betting data set associated with the first category of wagers,
wherein the second win probability model comprises a second algorithm based on a second historical game data set and a second historical betting data set associated with the second category of wagers.

18. The method of claim 17, wherein the first algorithm is determined based on a correlation of a first game characteristic and a first wager outcome,
wherein the second algorithm is determined based on a correlation of a second game characteristic and a second wager outcome.
